(19) United States
(12) Patent Application Publication
(10) Pub. No.: US 2012/0290483 A1
(43) Pub. Date: Nov. 15, 2012

(54) METHODS, SYSTEMS AND NODES FOR AUTHORIZING A SECURIZED EXCHANGE BETWEEN A USER AND A PROVIDER SITE

(76) Inventor: Moshe Hezrony, Montreal (CA)

(21) Appl. No.: 13/106,421

(22) Filed: May 12, 2011

(51) Int. Cl. G06Q 20/00

(52) U.S. Cl. 705/71

(57) ABSTRACT

Methods, systems and nodes for authorizing a securized exchange between a user and a provider site are described herein. User credentials are stored in a personal security module and in an authentication server. The personal security module is a user terminal or otherwise connects to a user terminal. The user terminal accesses the provider site, which in turn provides a unique transaction number to the authentication center and to the personal security module. The authentication center provides user authorization information to the provider site. When the personal security module sends the same unique transaction number to the authentication center, the authentication center provides the user authorization information to the personal security module. The user terminal uses the user authorization information for having the securized exchange with the provider site.

### TECHNICAL FIELD

This present disclosure relates generally to the field of electronic transactions and, more specifically, to methods, systems and nodes for authorizing a securized exchange between a user and a provider site.

### BACKGROUND

Electronic commerce is a process by which consumers take part in transactions with merchants over the Internet, i.e., where one's physical presence at a point of sale is substituted by electronically supplying account information or other relevant financial data. The advantage of electronic commerce from the consumer's point of view is the ability to choose from an abundance of products and merchants on the Internet, which tends to result in lower prices. As far as merchants are concerned, the advantage of electronic commerce is the ability to sell goods and services without maintaining a network of retailers, hence resulting in reduced labor and real estate costs.

Many electronic transactions are paid for by a credit account associated with a credit card issued by a credit card company or bank in the consumer's name, or via a debit draft, virtual money transfer, or any other method of payment. Specifically, consumers wishing to make a transaction electronically supply information about the credit account to the merchant, who then issues a request to the credit card company for authorizing the transaction. Thus, the physical presence of the credit card is inconsequential; rather, it is the account information associated with the credit card, that is, the credit account information, that renders the transaction possible. While this is a simple scheme, it has a tremendous flaw from a security standpoint. Specifically, because all the information necessary to complete a transaction is being divulged over the Internet, this information may be intercepted, or stolen, and used for illicit purposes. This is known as online fraud.

In cases where an electronic transaction involves reading a content of a magnetic strip on a credit card, or reading a content of an embedded chip, integral to a credit card, it is still possible to manufacture so-called “clone” cards containing copies of information that has been intercepted or stolen.

Online fraud costs merchants, consumers and credit card companies billions of dollars annually. There may also be long-term repercussions on consumers whose financial information has been stolen. In order to combat online fraud, credit card companies have invested in implementing techniques to detect fraudulent transactions by using, for example, address verification service, card verification number, customer history, geolocation, public records databases, etc. However, not only do these techniques fail to capture all fraudulent transactions, but for each successful detection of a fraudulent transaction, it has been found that similar numbers of legitimate transactions are rejected because they present symptoms—albeit false ones—of being fraudulent.

Another method of combatting fraud is to simply encrypt the credit account information that is exchanged over the Internet between the consumer and the merchant. Typically, encryption software, which may be provided in the form of a downloadable plug-in, is used for this purpose. However, this does not constitute a workable solution if the encryption software is not trusted by the credit card company and/or by the consumer. Moreover, such systems are prey for hackers on the Internet, who may attempt to break into the merchant's server behind the encryption software and thus illicitly obtain a large number of credit card numbers.

Passwords may be used to enhance the security of a transaction. The number of passwords used by individuals continues to grow and individuals are hard pressed to remember all of them. The evolution to client/server applications and the presence of the Internet have dramatically increased the number of passwords that any individual needs to remember. Therefore, using distinct passwords for each application is not a workable solution over the long term.

### SUMMARY

Therefore, there is a need for a technique for holding electronic transactions while overcoming the current security flaws of electronic commerce applications while providing users with solutions that are easy to use.

Therefore, according to the present disclosure, there is provided a method for authorizing a securized exchange between a user and a provider site. The method comprises sending a user key from a personal security module toward a provider site, sending the user key and a unique transaction number from the provider site toward an authentication server, sending the unique transaction number from the provider site toward the personal security module, storing the user key and the unique transaction number at the authentication server, sending user authorization information from the authentication server toward the provider site, sending the unique transaction number and user key authentication information from the personal security module toward the authentication server, authenticating the user key at the authentication server, matching the unique transaction number at the authentication server, sending the user authorization information from the authentication server toward the personal security module, and using the user authorization information for having the securized exchange between the user and the provider site.

According to the present disclosure, there is also provided a method for authorizing a securized exchange between a user and a provider site. The method comprises locally authenticating the user at a personal security module, sending a user key from the personal security module toward a provider site, receiving a unique transaction number from the provider site at the personal security module, sending the unique transaction number and user key authentication information from the personal security module toward the authentication server, receiving at the personal security module user authorization information from the authentication server, and using the user authorization information for having the securized exchange between the user and the provider site.

The present disclosure also relates to a method for authorizing a securized exchange between a user and a provider site. The method comprises receiving at the provider site a user key from a personal security module, sending the user key and a unique transaction number from the provider site toward an authentication server, sending the unique transaction number from the provider site toward the personal security module, receiving user authorization information from the authentication server, and using the user authorization information for having the securized exchange between the user and the provider site.

The present disclosure further relates to a method for authorizing a securized exchange between a user and a provider site. The method comprises receiving a user key and a unique transaction number from the provider site at an authentication server, storing the user key and the unique transaction number at the authentication server, sending user authorization information from the authentication server toward the provider site, receiving the unique transaction number and user key authentication information from a personal security module at the authentication server, authenticating the user key at the authentication server, matching the unique transaction number at the authentication server, and sending the user authorization information from the authentication server toward the personal security module. The user authorization information is for use in having the securized exchange between the user and the provider site.

The present disclosure further relates to system for authorizing a securized exchange between a user and a provider site. The system comprises the provider site for receiving a user key from a personal security module, sending the user key and a unique transaction number toward an authentication server, sending the unique transaction number toward the personal security module and receiving user authorization information from the authentication server. The system also comprises the authentication server for receiving and storing the user key and the unique transaction number, receiving from the personal security module user key authentication information and authenticating the user key, receiving the unique transaction number from the personal security module and matching the unique transaction number, and sending the user authorization information toward the personal security module. The system further comprises the personal security module for sending the user key toward the provider site, receiving the unique transaction number and forwarding it toward the authentication server along with the user key authentication information, and receiving and using the user authorization information for having the securized exchange between the user and the provider site.

The present disclosure also relates to a personal security module for authorizing a securized exchange between a user and a provider site. The personal security module comprises a data storage medium for holding identification and authentication parameters for the user, a communication interface for establishing a connection between the personal security module and other nodes, and a processor for controlling the communication interface and for communicating with, the other nodes therethrough, for reading and writing in the data storage medium, the processor being further for sending key authentication parameters toward a provider site, receiving a unique transaction number from the provider site, forwarding the unique transaction number along with the user key authentication information toward an authentication server, receiving user authorization information from the authentication server, and using the user authorization information for having the securized exchange between the user and the provider site.

The present disclosure further relates to a provider site for authorizing a securized exchange between a user and the provider site. The provider site comprises a communication interface for establishing connections with personal security modules and with an authentication server, and a secure transaction element having a temporary storage for keeping information related to a plurality of users having transactions with the provider site, the secure transaction element being operably connected to the communication interface for communicating with other nodes therethrough, the secure transaction element being further for receiving a user key from a personal security module, sending the user key and a unique transaction number toward the authentication server, sending the unique transaction number toward the personal security module, receiving user authorization information from the authentication server, and authorizing the securized exchange between the user and the provider site upon receiving from the personal security module a message using the user authorization information.

The present disclosure further relates to an authentication server for authorizing a securized exchange between a user and a provider site. The authentication server comprises a data storage medium for holding parameters for a plurality of users, a communication interface for establishing connections between the authentication server and a plurality of personal security modules and one or more provider sites, and a processor for controlling the communication interface and for communicating with other nodes therethrough, for reading and writing in the data storage medium, the processor being further for receiving from a given provider site a unique transaction number and a user key related to a given user, storing the user key and the unique transaction number, sending user authorization information to the given provider site, receiving the unique transaction number and user key authentication information from a personal security module of the given user, authenticating the user key at the authentication server, matching the unique transaction number, and sending the user authorization information to the personal security module. The user authorization information is for use in having the securized exchange between the user and the provider site.

The present disclosure also relates to an authentication center for authorizing a securized exchange between a user and a provider site. The authentication center comprises a data center for holding parameters for a plurality of users. The authentication center also comprises an accord server for establishing connections between the data center and a plurality of personal security modules, for authenticating messages received from the plurality of users, for establishing connections between the data center and one or more provider sites, for authenticating messages received from the one or more provider sites and for coordinating transactions between the plurality of users and the one or more provider sites using unique transaction numbers. The authentication center further comprises a correspondence server for forwarding messages from the data center toward the one or more provider sites. The data center is further for receiving from a given provider site a unique transaction number, sending user authorization information to the given provider site, receiving the unique transaction number from a given personal security module, and sending the user authorization information to the given personal security module. The user authorization information is for use in having the securized exchange between the user and the provider site.

The foregoing and other features will become more apparent upon reading of the following non-restrictive description of illustrative embodiments thereof, given by way of example only with reference to the accompanying drawings.

### BRIEF DESCRIPTION OF THE DRAWINGS

Embodiments of the disclosure will be described by way of example only with reference to the accompanying drawings, in which:

FIG. 1 shows steps in a first exemplary embodiment of a method for authorizing a securized exchange between a user and a provider site;

FIG. 2 is a block diagram of an exemplary system for authorizing a securized exchange between a user and a provider site;

FIG. 3 is a functional block diagram of an exemplary personal security module;

FIG. 4 is a functional block diagram of an exemplary authentication server.

### DETAILED DESCRIPTION

Systems, methods and nodes described herein provide secure access for a user to a provider site by forming a loop between a personal security module, an authentication center (or an authentication server), and the provider site. The personal security module contains secure information for authenticating the user, also called a key owner in the context of the present disclosure. The authentication center holds a copy of the secure information for at least this user and may do so for a plurality of other users. The provider site comprises a script for receiving information from the personal security module when the user initiates a transaction, for providing a unique transaction number to the personal security module, and for forwarding the unique transaction number and the received information to the authentication center. The authentication center stores the received information. The authentication center forwards user authorization information to the provider site. The authentication center also receives the unique transaction number from the personal security module. The act of receiving the same unique transaction number from both the personal security module and the provider site closes the loop at the authentication center. Having received the unique transaction number from the personal security module, the authentication center forwards the user authorization information to the personal security module. The personal security module may then use the user authorization information to have an authorized and securized exchange with the service provider site and hold its transaction. All ensuing communications for this transaction may then be encrypted using encryption keys that remain valid for the duration of the transaction.

In the context of the present disclosure, the personal security module may be physically combined features of a user terminal, as a single entity. Alternatively, the personal security module may be a separate component that is capable of connecting to a user terminal The personal security module itself or a user terminal connected thereto may take the form of various electronic devices, including for example a personal computer, a laptop computer, a mobile terminal, a cellular terminal, a personal digital assistant, an IP television desktop terminal, and the like. The personal security module may be portable. This is the case in embodiments where the personal security module is implemented as a separate device connectable to a user terminal and in embodiments where the personal security module is implemented as a laptop computer, a cellular terminal, and like portable devices. In some other embodiments, the personal security module may consist of or may be integrated within a fixed computer station.

The personal security module stores a key of the user, the key being usable for authenticating the owner of the personal security module and, by extension, the user of a terminal. The key owner may connect the personal security module to a terminal owned by another person, in which case credentials of the key owner are used in setting up a session for the key owner while the personal security module remains connected to the terminal.

In embodiments where the personal security module is a distinct entity from the user terminal, it may be connected to the user terminal by use of a universal serial bus (USB) connection, a serial port connection, a Bluetooth™ connection, an infrared connection, an optical connection, a radio frequency identification (RFID) connection, and the like. In cases where the user terminal is a cellular terminal, the personal security module may optionally be a subscriber identity module (SIM) card or other module embedded in or connected to the cellular terminal. It is well-known to those of ordinary skills in the art that when a SIM card is installed within a cellular terminal the resulting combination becomes, from the standpoint of its user, a single entity. In the same vein, for purposes of the present disclosure, a standalone personal security module and a combination formed of a separate personal security module connected to a user terminal generally perform similarly and may thus alternatively be referred to as a “personal security module” or as a “user terminal”.

The provider site may be any type of server, including a cloud server or a virtual server, capable of performing a transaction or a session with the personal security module or user electronic device. The provider site may support a commercial transaction involving exchange of monies in any direction between the personal security module and the provider site. The provider site may support a non-commercial transaction involving exchange of sensitive information, such as for example medical or legal information, between the personal security module and the provider site.

The authentication center may comprise a single node, called an authentication server, or may consist of several nodes. Whether the authentication center comprises a single server or several nodes brings limited impact on the personal security module or on the provider site. The internal structure of the authentication center does not impact the steps and processes of the personal security module and/or of the provider site, though some details such as addressing of messages exchanged with the authentication center may differ somewhat based on its internal structure. A transaction, or session, established between the personal security module and the provider site may be of any duration and may comprise any amount of exchanged information, from a simple login to a longer term session such as a working session for a telecommuter. The user authorization information may for example comprise one or more keys for use in encrypting and decrypting messages exchanged between the personal security module and the provider site. Examples of keys that may be used in this context comprise symmetric keys and asymmetric keys.

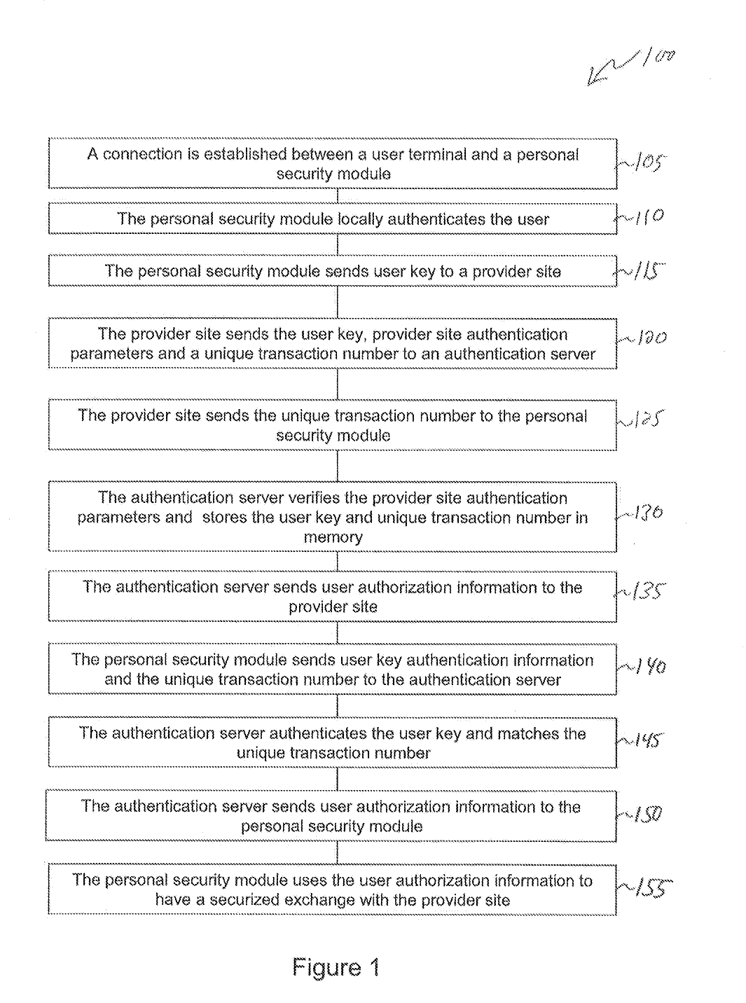

Referring to FIG. 1, there are shown steps in a first exemplary embodiment of a method for authorizing a securized exchange between a user and a provider site. A sequence 100 describes an embodiment in which a personal security module is a separate entity from a user terminal. Some steps related to connecting the personal security module and the user terminal would not be present in other embodiments in which the personal security module and the user terminal are fully integrated. The sequence 100 is thus exemplary and not limiting. The exemplary sequence 100 comprises a first step 105 of establishing a connection between a user terminal and a personal security module. The personal security module locally authenticates the user at step 110. This local authentication may be based on a password or a personal identification number (PIN) entered at the user terminal by the user. Alternatively, the user terminal may use a biometric identification of the user, or the personal security module may contain a biometric authentication mechanism. At step 115, the personal security module sends a user key to the provider site. The user key may comprise a single information element or may alternatively comprise a plurality of user key parameters. The provider site sends the user key, provider site authentication parameters and a unique transaction number to an authentication server at step 120. The provider site also sends the unique transaction number to the personal security module at step 125. At step 130, the authentication server verifies the provider site authentication parameters and stores the user key and the unique transaction number in a memory. The authentication server sends user authorization information to the provider site at step 135. The personal security module sends at step 140 user key authentication information and the unique transaction number to the authentication server. The authentication server authenticates the user key and matches the unique transaction number at step 145. The authentication server sends at step 150 the user authorization information to the personal security module. The personal security module may then use the user authorization information to have an authorized and securized exchange with the provider site at step 155.

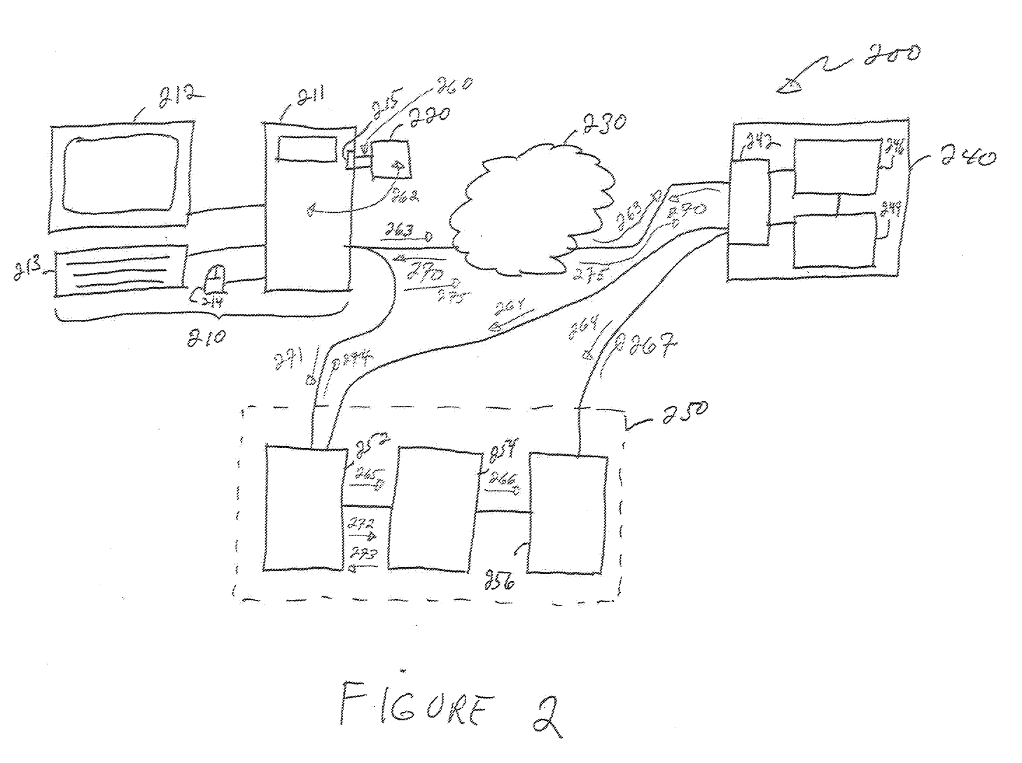

Referring now to FIG. 2, there is shown a block diagram of an exemplary system for authorizing a securized exchange between a user and a provider site. A system 200 comprises a user terminal 210, consisting of anyone of various types of electronic devices, a personal security module 220, a data network 230, a provider site 240 and an authentication center 250. The shown user terminal 210 comprises a processing unit 211, a display 212, a keyboard 213, a mouse 214, and a USB interface 215, as are well known in the art. Those skilled in the art will appreciate that other types of user terminals may differ. For example, a laptop computer may integrate the various elements 211-215 in a single unit. A cellular terminal may operate, in the context of FIG. 2, as a user terminal without having all of the elements 211-215. The personal security module 220 is connected to the user terminal 210 via anyone of the aforementioned or similar connection technologies. The data network 230 may comprise the Internet, an intranet, a dial-up network, an asynchronous transfer mode (ATM) network, and the like. As expressed hereinabove, the user terminal 210 and the personal security module 220 may, in some embodiments, be integrated in a single physical device. The system 200 comprising the physically distinct personal security module 220 and user terminal 210 is thus exemplary and not limiting. The data network 230 may be considered transparent in the context of the present disclosure. The exemplary provider site 240 comprises a communication interface 242, a secure transaction element 244 and a browser application 246. The communication interface 242 may actually be implemented as a plurality of interface components for connection towards the data network 230 and towards the authentication center 250. Only one communication interface 242 is shown for simplicity of the present disclosure, without loss of generality. The provider site 240 may be substituted by a combination of nodes, each node supporting one or more parts of the features described in relation of to the present description of the provider site 240. For example, several nodes in a cloud computing network may form the provider site 240. The provider site 240 may comprise many more components (not shown) that are frequently present in servers, such as for example a memory, database, or other storage component, as is well-known in the art.

The authentication center 250 may be split into further components. In the exemplary embodiment of FIG. 2, the authentication center 250 comprises an accord server 252, a data center 254 and a correspondence server 256. Those of ordinary skill in the art will appreciate that malicious parties, such as “hackers”, may face very large hurdles in attempting to compromise the security of the exemplary authentication center 250 of FIG. 2 because no attempt may fully succeed without breaking into all of the components 252, 254, 256 of the authentication center 250. Such malicious parties would not gain any important benefit in breaking into one of the components 252, 254, 256 without gaining access to the remaining components of the authentication center 250. Regardless, in an embodiment, the authentication center 250 may be implemented as an authentication server, depicted hereinbelow in relation to the description of FIG. 4.

At step 260, if the personal security module is distinct from the user terminal 210, a user initiates connection of the personal security module 220 to the user terminal 210, using one of a USB connection, a Bluetooth™ connection, an infrared connection, and the like. The personal security module 220 locally authenticates the user at step 262. This may be done by requesting the user to enter credentials in form of a password, a PIN, biometric information, or by similar means. The personal security module 220 matches the entered credential against an encrypted credential stored permanently or semi-permanently in the personal security module 220.

Following successful local authentication, the personal security module 220 launches an application of the user terminal 210, such as for example a login to the user terminal 210, a login to an active directory or to a server application, a login to a website, to a portal, or any local application or other web application. The user selects a task to be performed. The personal security module 220 retrieves from an internal, secure memory area a pre-saved destination address, which may consist of a uniform resource locator (URL) for the provider site 240. The personal security module 220 requests the establishment of a transaction by connecting to the desired application URL of the provider site 240. The personal security module 220 then scans a web page at the browser application 246 of the provider site 240 and searches for a script of the secure transaction element 244. Once the personal security module 220 has found the script, it sends to the secure transaction element 244 a user key related to the user at step 263. Optionally, the user key may be encrypted by the personal security module 220. The secure transaction element 244 may comprise user information for the user of the personal security module 220, obtained at the time of an earlier transaction as will be explained hereinbelow. Responsive to step 263, the secure transaction element 244 decrypts the user key, if it has been encrypted. The secure transaction element 244 sends two distinct information packages, at steps 264 and 270.

A first information package (step 264) is sent towards the authentication center 250, and is specifically received by the accord server 252 and by the correspondence server 256. The first information package comprises the user key and a unique transaction number for the transaction that has been requested by the personal security module 220. The first information package may further comprise information, for example, authentication information about the service provider site 240, to allow the authentication center 250, specifically the accord server 252 and the correspondence server 256, to authenticate the provider site 240 and, in the case of the correspondence server 256, to register the provider site 240. The first information package may be encrypted by the secure transaction element 244.

The accord server 252 verifies if the received provider site authentication information matches what is expected from that particular secure transaction element 244. If the first information package has been encrypted by the secure transaction element 244, further processing of the first information package is conditional to successful decryption. If the accord server 252 accepts the first information package, it forwards the first information package at step 265 to the data center 254. The data center 254 has a copy of the credentials of the personal security module 220. The data center 254 parses the content of the first information package and stores the user key and the unique transaction number. The data center 254 then creates three transaction packages. A first transaction package is for use in granting access to the user terminal 210 at the provider site 240. The first transaction package comprises user authorization information, comprising for example keys for authenticating, encrypting and decrypting messages that may eventually be exchanged between the provider site 240 and the user terminal 210. A second transaction package comprises new authentication and/or encryption and decryption parameters for use at a next transaction to be eventually held between the user terminal 210 and the personal security module 220, on one hand, and the provider site 240, on the other hand. A third transaction package may contain information of a less sensitive nature about the user, comprising for example first and last names of the user, an email address, a phone number, and the like. At step 266, the three transaction packages are forwarded to the correspondence server 256. The data center 254 also keeps a copy of the three transaction packages. If the correspondence server 256 has registered the provider site 240, the correspondence server 256 forwards the three transaction packages towards the secure transaction element 244 at step 267. If a destination field in the transaction packages does not correspond to any registered provider site, the correspondence server 256 may block a transmission of the transaction packages. This last feature of the correspondence server 256 prevents setting up of transactions with any potential malicious provider site.

A second information package (step 270) is sent by the provider site 240 towards the personal security module 220. The second information package comprises the unique transaction number, which is optionally encrypted. The personal security module 220 prepares user key authentication information, which is an authentication response based on the user key. The personal security module 220 sends toward the authentication center 250 a message comprising the unique transaction number, the user key authentication information, and optionally comprising other information elements relevant to the type of transaction to be established with the provider site 240, at step 271. The message may be directed specifically to the accord server 252 and may be encrypted by the personal security module 220. The accord server 252 decrypts the message, if applicable, and transmits it to the data center 254 at step 272. The data center 254 authenticates the user key, and matches the unique transaction number received at step 272 with the first package having been received earlier. Using this match, the data center 254 can correlate the unique transaction number received at step 272 with the three transaction packages having been prepared following step 265. The data center 254 creates two additional transaction packages. A fourth transaction package is for use at the user terminal 210 to gain access to the provider site 240 and comprises information elements corresponding to those of the first transaction package. The first and fourth transaction packages may be identical, for example if symmetric keys are used, or complementary, for example if asymmetric keys are used. A fifth transaction package comprises new authentication and/or encryption and decryption parameters for use at a next transaction to be eventually held between the user terminal 210 and the personal security module 220, on one hand, and the provider site 240, on the other hand. As such, the fifth transaction package is complementary to the second transaction package.

The data center 254 sends the fourth and fifth transaction packages to the accord server 252 at step 273. The accord server 252 forwards the fourth and fifth transaction packages, possibly in encrypted form, towards the user terminal 210 and personal security module 220 at step 274. The personal security module 220 receives the fourth and fifth transaction packages and decrypts their content, if applicable. The fifth transaction package is stored for use in a next transaction at the personal security module 220. The personal security module 220 contacts the provider site 240 at step 275, using information elements of the fourth transaction package. Because these information elements comprise the user authorization information, which may for example comprise keys for authenticating, encrypting and decrypting messages, matching those that the secure transaction element 244 has earlier received at step 267, access authorization is granted to the user terminal 210 at the provider site 240.

The transaction between the user terminal 210 and the provider site 240 may eventually end. The user terminal 210 may later initiate setting up of a new transaction with the same provider site 240. The above described sequence of steps 260-275 is generally repeated for a next transaction. In the course of setting up the next transaction, the step 263 of sending a user key related to the user from the personal security module 220 to the secure transaction element 244 is executed again. This time, additional information that has earlier been obtained at the personal security module 220 from the fifth transaction package may be sent at the same time. This additional information may be matched at the secure transaction element 244 with the earlier received information of the second transaction package. Use of this additional information, comprising for example, authentication and/or encryption and decryption parameters obtained in a previous transaction, provides enhanced security to setting up transactions in the system 200 by linking successive transactions in a chained process. In the chained process, a transaction depends on a previous one.

In the unlikely event that the personal security module 220 is cloned by copying its entire secret content into another device, alternating uses of the legitimate device and of the cloned device result in a mismatch of the third transaction package in the provider site 240 and of the fifth transaction package in the legitimate personal security module 220. The user is denied access at a next transaction and may request an operator of the authentication center to re-initiate its credentials stored in the personal security module 220 and in the data center 254. This re-initiation of the user credentials effectively blocks the cloned device. Of course, another alternative may be to simply replace the personal security module 220 with a new one, with an equivalent result.

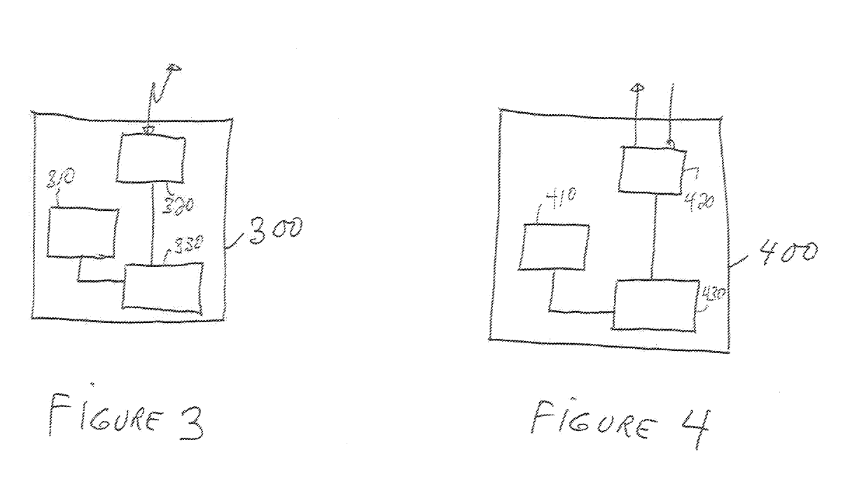

FIG. 3 shows a block diagram of an exemplary personal security module, as used in the system of FIG. 2. A personal security module 300 provides access security for a user desiring to set up a securized exchange with a provider site. The personal security module 300 comprises a data storage medium 310, a communication interface 320 and a processor 330. The data storage medium 310 permanently or semi-permanently holds various credentials for the user, comprising for example a user key and identification, authentication and encryption parameters for the user. The communication interface 320 may establish a connection between the personal security module 300 and a physically separate user terminal. This connection may rely on various technologies, as mentioned hereinabove. Through this connection, the personal security module 300 may connect via the user terminal to other entities and nodes beyond the user terminal. In embodiments where the personal security module 300 is standalone and supports generic features of a user terminal, the communication interface 320 may establish connection directly with other entities and nodes. The processor 330 controls the communication interface 320 and communicates with the user terminal and with other nodes therethrough. The processor 330 reads and writes in the data storage medium 310. In some embodiments, the personal security module 300 may be of a small size and comprise its own power supply, such as a for instance a battery or a connection external power supply connection, rendering the personal security module 300 portable.

The processor 330 locally authenticates the user, for example by requesting the user terminal to display a query for a password, a PIN code, or using a biometric reader element of the personal security module 300 and by verifying a response to the query. The processor 330 reads a user key from the data storage medium 310 and forwards these information elements toward a provider site. The processor 330 receives a unique transaction number from the provider site and may store this number in the data storage medium 310. The processor 330 prepares user key authentication information, which is an authentication response result based on the user key. The processor 330 then forwards the user key authentication information and the unique transaction number toward an authentication server and then receives user authorization information from the authentication server. The processor 330 may store at least some parts of the user authorization information in the data storage medium 310. The processor 330 uses the user authorization information at to have the securized exchange with the provider site.

The personal security module 300 may further perform the various functions and features of the personal security modules and user terminals introduced in relation to the descriptions of FIGS. 1 and 2. In some embodiments, some of the functions of the processor 330 may be delegated to a processor (not shown) of the user terminal to which the personal security module 300 is connected.

Referring to FIG. 4, there is shown a block diagram of an exemplary authentication server. In the embodiment of FIG. 4, an authentication server 400 implements the various features of functions of the authentication center of FIG. 2 within a single node. The authentication server provides access security for a user to desiring to set up a securized exchange with a provider site. In an embodiment, the authentication server 400 comprises a data storage medium 410, a communication interface 420, and a processor 430. The data storage medium 410 holds identification and authentication parameters and, generally, various types of credentials for a plurality of users. The communication interface 420 establishes connections between the authentication server and a plurality of personal security modules and user terminals as well as with one or more provider sites. The processor 430 controls the communication interface 420 and communicates with other nodes therethrough. The processor 430 reads and writes information in the data storage medium.

The processor 430 receives from a given provider site a unique transaction number and a user key related to a given user. The processor 430 may verify these information elements, and may for this purpose rely at least in part on credentials for the given provider site an on credentials for the given user, both of which are held in the data storage medium 410. The processor 430 then stores the user key and the unique transaction number in the data storage medium 410. The processor 430 sends user authorization information to the given provider site. The processor 430 also receives the unique transaction number and user key authentication information from a user terminal of the given user. The processor 430 authenticates the user key, matches the unique transaction number, and may also verify other credentials of the given user by consulting the data storage medium 410. The processor 430 then sends the user authorization information to the given user terminal.

The authentication server 400 may further perform the various functions and features of the authentication server and authentication center introduced in relation to the descriptions of FIGS. 1 and 2.

It is to be understood that the present disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been described hereinabove by way of illustrative embodiments thereof, it can be modified, without departing from the spirit, scope and nature of the subject disclosure.

What is claimed is:

1. A method for authorizing a securized exchange between a user and a provider site comprising:
sending a user key from a personal security module toward a provider site;
sending the user key and a unique transaction number from the provider site toward an authentication server;
sending the unique transaction number from the provider site toward the personal security module;
storing the user key and the unique transaction number at the authentication server;
sending user authorization information from the authentication server toward the provider site;
sending the unique transaction number and user key authentication information from the personal security module toward the authentication server;
authenticating the user key at the authentication server;
matching the unique transaction number at the authentication server;
sending the user authorization information from the authentication server toward the personal security module; and
using the user authorization information for having the securized exchange between the user and the provider site.

2. The method of claim 1, wherein:
information elements exchanged between the personal security module, the provider site and the authentication server are encrypted before each step of sending and decrypted after each step of receiving.

3. The method of claim 1, wherein:
the user authorization information comprises a key for use in encrypting and decrypting messages exchanged between a user terminal connected to the personal security module and the provider site.

4. The method of claim 1, wherein:
the user authorization information comprises a key for use in encrypting and decrypting messages exchanged between the personal security module and the provider site.

5. The method of claim 1, wherein:
the user authorization information comprises a chaining parameter for use in a next transaction of the personal security module.

6. The method of claim 5, further comprising:
following matching of the unique transaction number, sending the chaining parameter from the authentication server to the provider site.

7. The method of claim 6, wherein:
the user key sent from the personal security module toward the provider site comprises an earlier chaining parameter obtained in a previous transaction of the personal security module.

8. The method of claim 1, further comprising:
locally authenticating the user at the personal security module before the step of sending the user identification and the authentication parameters.

9. The method of claim 1, wherein:
sending the user key and the unique transaction number from the provider site toward the authentication server further comprises sending provider site authentication parameters; and
the authentication server verifies the provider site authentication parameters.

10. The method of claim 1, further comprising:
following matching of the unique transaction number, sending non-sensitive user information from the authentication server to the provider site.

11. The method of claim 1, wherein:
the personal security module is a portable device.

12. A method for authorizing a securized exchange between a user and a provider site comprising:
locally authenticating the user at a personal security module;
sending a user key from the personal security module toward the provider site;
receiving a unique transaction number from the provider site at the personal security module;
sending the unique transaction number and user key authentication information from the personal security module toward the authentication server;
receiving at the personal security module user authorization information from the authentication server; and
using the user authorization information for having the securized exchange between the user and the provider site.

13. A method for authorizing a securized exchange between a user and a provider site comprising:
receiving at the provider site a user key from a personal security module;
sending the user key and a unique transaction number from the provider site toward an authentication server;
sending the unique transaction number from the provider site toward the personal security module;
receiving user authorization information from the authentication server; and
using the user authorization information for having the securized exchange between the user and the provider site.

14. The method of claim 13, wherein:
the unique transaction number is for use for coordination between the personal security module and the authentication server.

15. A method for authorizing a securized exchange between a user and a provider site comprising:
receiving a user key and a unique transaction number from the provider site at an authentication server;
storing the user key and the unique transaction number at the authentication server;
sending user authorization information from the authentication server toward the provider site;
receiving the unique transaction number and user key authentication information from a personal security module at the authentication server;
authenticating the user key at the authentication server;
matching the unique transaction number at the authentication server; and
sending the user authorization information from the authentication server toward the personal security module;
wherein the user authorization information is for use in having the securized exchange between the user and the provider site.

16. A system for authorizing a securized exchange between a user and a provider site comprising:
the provider site for:
receiving a user key from a personal security module,
sending the user key and a unique transaction number toward an authentication server,
sending the unique transaction number toward the personal security module, and
receiving user authorization information from the authentication server;
the authentication server for:
receiving and storing the user key and the unique transaction number,
receiving from the personal security module user key authentication information and authenticating the user key,
receiving the unique transaction number from the personal security module and matching the unique transaction number, and
sending the user authorization information toward the provider site and toward the personal security module; and
the personal security module for:
sending the user key toward the provider site,
receiving the unique transaction number and forwarding it toward the authentication server along with the user key authentication information, and
receiving and using the user authorization information for having the securized exchange between the user and the provider site.

17. A personal security module for authorizing a securized exchange between a user and a provider site comprising:
a data storage medium for holding identification and authentication parameters for the user;
a communication interface for establishing a connection between the personal security module and other nodes; and
a processor for controlling the communication interface and for communicating with the other nodes therethrough, for reading and writing in the data storage medium, the processor being further for:
sending key authentication parameters toward a provider site,
receiving a unique transaction number from the provider site,
forwarding the unique transaction number along with the user key authentication information toward an authentication server,
receiving user authorization information from the authentication server, and
using the user authorization information for having the securized exchange between the user and the provider site.

18. A provider site for authorizing a securized exchange between a user and the provider site comprising:
a communication interface for establishing connections with personal security modules and with an authentication server; and
a secure transaction element having a temporary storage for keeping information related to a plurality of users having transactions with the provider site, the secure transaction element being operably connected to the communication interface for communicating with other nodes therethrough, the secure transaction element being further for:
receiving a user key from a personal security module,
sending the user key and a unique transaction number toward the authentication server,
sending the unique transaction number toward the personal security module,
receiving user authorization information from the authentication server, and
authorizing the securized exchange between the user and the provider site upon receiving from the personal security module a message using the user authorization information.

19. An authentication server for authorizing a securized exchange between a user and a provider site comprising:
a data storage medium for holding parameters for a plurality of users;
a communication interface for establishing connections between the authentication server and a plurality of personal security modules and one or more provider sites; and
a processor for controlling the communication interface and for communicating with other nodes therethrough, for reading and writing in the data storage medium, the processor being further for:
receiving from a given provider site a unique transaction number and a user key related to a given user,
storing the user key and the unique transaction number,
sending user authorization information to the given provider site,
receiving the unique transaction number and user key authentication information from a personal security module of the given user,
authenticating the user key at the authentication server,
matching the unique transaction number, and
sending the user authorization information to the personal security module;
wherein the user authorization information is for use in having the securized exchange between the user and the provider site.

20. An authentication center for authorizing a securized exchange between a user and a provider site comprising:
a data center for holding parameters for a plurality of users;
an accord server for establishing connections between the data center and a plurality of personal security modules, for authenticating messages received from the plurality of users, for establishing connections between the data center and one or more provider sites, for authenticating messages received from the one or more provider sites and for coordinating transactions between the plurality of users and the one or more provider sites using unique transaction numbers; and
a correspondence server for forwarding messages from the data center toward the one or more provider sites;
wherein the data center is further for:
receiving from a given provider site a unique transaction number,
sending user authorization information to the given provider site;
receiving the unique transaction number from a given personal security module, and
sending the user authorization information to the given personal security module;
wherein the user authorization information is for use in having the securized exchange between the user and the provider site.

21. The authentication center of claim 20, wherein:
the correspondence server is further for conditionally forwarding a message sent from the data center toward the given provider site based on a registration of the given provider site at the correspondence server.
